(19) United States
(12) Patent Application Publication
(10) Pub. No.: US 2002/0191913 A1
(43) Pub. Date: Dec. 19, 2002

(54) Apparatus and method for processing light

(75) Inventors: G. Benjamin Hocker, Minnetonka, MN (US); Daniel W. Youngner, Maple Grove, MN (US); Stephen D. Senturia, Bookline, MA (US); Erik R. Deutsch, Cambridge, MA (US); Michael A. Butler, Albuquerque, NM (US); Michael B. Sinclair, Albuquerque, NM (US); Thomas E. Plowman, Cary, NC (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc.

(21) Appl. No.: 09/877,323

(22) Filed: Jun. 8, 2001

(51) Int. Cl. G02B 6/34; G02B 6/28

(52) U.S. Cl. 385/37; 385/24; 359/130

(57) ABSTRACT

Optical processing apparatus for processing a stream of light. The apparatus includes a light input emitted, for example, by fiber optic cable. Multiple wavelength bands of light are, typically, emitted and transmitted in a direction parallel to an axis. The apparatus also includes a plurality of receptors which are positioned at defined locations spaced from one another. A diffracting member is employed to diffract the wavelength bands of light transmitted parallel to the axis. In one embodiment of the invention, the diffracting member is a controllable diffraction grating. The wavelength bands are selectively diffracted to various of the receptors. The apparatus further includes a controller for selectively adjusting the diffracting member to independently vary a particular receptor to which any one wavelength band is diffracted.

### STATEMENT REGARDING FEDERALLY SPONSORED RESEARCH OR DEVELOPMENT

This invention was made with Government support under Contract No. N66001-97-C-8620 awarded by the Defense Advanced Research Projects Agency, and under Contract No. DE-AC04-94AL85000 awarded by the U.S. Department of Energy. The Government has certain rights in the invention.

### TECHNICAL FIELD

The present invention relates broadly to the processing of light. More specifically, however, it deals with directing a multiplicity of individual streams of light, each having a different wavelength band, to one or more distinct outputs or receptors. It enables the direction of each of the wavelength bands to be changed in order to direct the bands to different output locations, as desired. An apparatus and method in accordance with the invention are particularly useful for controlling transmission of light with regard to optical communication systems and, more particularly, for being used in a programmable wavelength selective switch.

### BACKGROUND OF THE INVENTION

In general, optical communication systems involve the encoding of information on beams of light and the transmission of this light through thin transparent optical fibers and other optical components. Fiber optic communications provides advantages over conventional electrical communications over copper communications wire. For instance, optical fibers are not sensitive to electrical noise because light signals rather than electrical signals are transmitted through the optical fiber. In addition, because the frequency of the light used in optical communications is much greater than the frequency of electrical signals used in conventional copper wire, the communications rate for optical communications systems can be much greater than the communications rate of copper wire communications systems. Although the communication rate for fiber optic systems already is high, the demand for ever higher rates is continually increasing, as is the demand for an ability to selectively direct and switch light signals. Wavelength Division Multiplexing (WDM) has been developed in an attempt to support such increased demand. With WDM, several wavelength bands of light, following common paths through optical fibers and other components, may be utilized at the same time with each band carrying different information. For instance, a light beam may comprise four light streams, each having a different wavelength band (for example, wavelength bands around 1.5510, 1.5520, 1.5530, and 1.5540 micrometers). The four streams may all be sent along a single path through an optical fiber, with each stream carrying different information. Thus, a single optical fiber can be used to transmit four times the information, as compared to a fiber used for a single light stream comprised of a single wavelength band.

Because each light stream can be modulated to carry information at a very high rate, for example, at 10 Gbits/second, a WDM transmission having four light streams of four distinct wavelength bands, transmitted simultaneously, would yield data rates of approximately four times greater, or about 40 Gbits/second, through a single optical fiber.

In optical communication systems and elsewhere, it is desirable to separate, redirect, and combine separate light beams. As is well known to those skilled in the art of optics, it is possible to separate, redirect and combine light beams, for example, by use of mirrors and lenses. Mirrors can be miniaturized and their positions switched and controlled to allow the desired control of the directions of light beams. However, this technique controls the entire light beam in the same fashion, and cannot individually and separately control the individual light streams of different wavelength bands which comprise the light beam. In order to further separate the individual light streams of different wavelength bands within the light beam, well-known optical devices such as wavelength-selective filters, prisms, and conventional diffraction gratings can be used. A limitation of these devices is that different wavelengths of light are processed in a fixed manner and in a way that cannot be flexibly or selectively controlled. For example, it is well-known that a conventional diffraction grating diffracts light in a defined and fixed angular relationship, with shorter wavelengths being directed at a smaller angle relative to the input beam, and longer wavelengths directed at larger angles. This angular relationship is fixed and thereby limits its usefulness in directing light streams with different wavelength bands. That is, a diffraction grating cannot be varied or switched to rearrange this angular relationship between two light streams with different ranges of wavelength: It cannot be switched to reverse the angular directions of the two streams or to direct both light streams having different wavelength bands in the same direction.

Technology has been described recently for controllable or programmable diffraction grating devices. A controllable diffraction grating may employ an electrostatic system for use in moving a diffraction grating element. Typically, such devices include an array of grating elements that are able to be individually displaced in at least one direction to collectively control the diffraction of a stream of light relative to the grating device. Generally, a grating element is constructed such that at least a portion of the element is made of a resilient material. A reflective coating is applied to one side of the element to diffract the light stream.

The element also includes a conductive or magnetic material to thereby allow an electronic or magnetic force to be applied in order to flex the element. When the individual elements are flexed in certain manners, the diffraction of the light stream with respect to the array of elements is changed. The change in angle of diffraction thereby alters the direction in which the light stream is directed.

U.S. Pat. No. 5,905,571 to Butler et al. discloses an optical apparatus for forming correlation spectrometers and optical processors. It teaches a diffractive optical element formed on a substrate comprising a plurality of controllable grating elements with a varying height of adjacent grating elements, and a modulation means to switch between two grating states in order to obtain two different correlations with the incident light beam. This diffractive optical element is used for correlation spectroscopy. A single input light beam is diffracted in a specified single output direction in order to perform an optical correlation function. In this teaching, a single specific angular direction θ is selected for the diffractive light with respect to the incident light, and the apparatus used to alter the intensities of different wavelengths that are diffracted at that angle θ. This patent is hereby incorporated by reference.

U.S. Pat. No. 5,677,783 to Bloom et al. describes a deformable grating apparatus for modulating a light beam. It teaches modulating the intensity of an input ray of light of a determinable wavelength diffracted into a viewing cone, for use as an optical display.

None of these devices has been utilized to separate and selectively direct multiple input wavelength ranges from a single input beam to multiple output locations. None of these devices has been utilized to separate and selectively direct multiple input wavelength ranges from multiple input beams to a single output location, nor to multiple output locations.

There exist, therefore, additional unmet needs for methods and apparatus for processing light in useful ways. The prior art defines needs to selectively control the directions of individual light streams of different wavelength bands. There are needs to direct individual light streams of different wavelength bands from one or more sources to outputs, and to selectively switch between different sets of directions.

The present invention considers these problems and dictates and addresses the needs of the prior art. The present invention is an apparatus for processing a band of light to achieve the solution of problems and accomplishment of goals necessitated by the prior art.

### SUMMARY OF THE INVENTION

It is an object of the present invention to separate and selectively direct each of multiple input wavelength bands of a light beam to an intended output. Another object of the invention is the selected switching of an output receptor to which a defined wavelength band is directed. Such switching is accomplished for one wavelength band independently of other wavelength bands.

It is another object of the invention to direct different input wavelength bands, selectively, to a common output. It is a further object of the present invention to enable the division and direction of a single wavelength band to multiple outputs. It is a further object of the present invention to selectively direct each of multiple input wavelength bands of multiple input light beams to intended outputs.

To achieve these objects, the present invention is an apparatus and method for processing light. A beam of light is transmitted along an axis from a source. The beam of light contains individual light streams, each having a different wavelength band. Such a light stream within a wavelength-band may contain a signal carrying information. The apparatus also includes a plurality of receptors which are positioned at defined locations. A diffracting member is provided to diffract the wavelength bands of light transmitted from the source. The diffracting member effects diffraction of the wavelength bands to one or more of the receptors. A controller is provided to enable selective adjustment of the member to accomplish diffraction of a selected wavelength band independent of other wavelength bands. The controller thereby acts to direct a signal contained within one or more selected wavelength bands to be directed to one or more recipients. For example, a signal may comprise information such as voice or data and may be communicated within one wavelength band.

The apparatus can comprise at least one fiber optic emitter. Further, the diffracting member can include multiple grating elements which operate to diffract at least one output stream of light having a wavelength band and carrying a signal and to direct that signal toward a predetermined receptor.

A diffractive member for use in accordance with the present invention may comprise a plurality of grating elements for diffracting incoming light, a support to which the grating elements are mounted, and means for selectively adjusting the grating elements. The elements may be optically reflective or transmissive. The adjustment changes the reflective phase of the light reflected from, or transmitted through, each element, thereby controlling the direction in which each wavelength band of light is individually and selectively directed to a predetermined receptor. The invention includes a method for directing a particular wavelength band or multiple wavelength bands of incoming light. The method includes a step of providing a controllable diffraction grating which includes a plurality of diffraction grating elements. The adjustments of the diffraction grating elements necessary to direct a predetermined wavelength band of the incoming light to a predetermined output receptor are ascertained. Such adjustments may be, for example, adjustments of the position of each element. An array or group of diffraction grating elements are positioned at the ascertained positions and work together to effect diffraction of the predetermined wavelength band of light to a predetermined output receptor.

The invention may be designed to work with a plurality of input wavelength bands. Steps, as indicated hereinafter, may be added as desired. For a diffracting grating utilizing reflective elements, the positions of the grating elements that are necessary to direct a first predetermined wavelength band to a first predetermined output receptor and each additional predetermined wavelength band to a specified output receptor are ascertained. The diffraction grating elements are positioned at the ascertained positions to diffract each of the input wavelength bands of light to the specified set of output receptors.

This embodiment may also be utilized to switch the directions of output signals so that the signals are independently transmitted to the same receptor or to different output receptors. The method can include additional steps to facilitate these functions. For the first disposition of the switch, the apparatus ascertains the first set of positions of the grating elements that are necessary to direct the input wavelength bands to a first specified set of output receptors. For the second disposition of the switch, the apparatus ascertains the second set of positions of the grating elements that are necessary to direct the input wavelength bands to the second desired set of output receptors. Thus by switching the grating elements between the two ascertained sets of positions, the input wavelength bands are switched between the two sets of output receptors.

In addition to the case where there is a single input beam of light containing multiple wavelength bands, the apparatus of this invention may be employed to direct and to switch input wavelength bands in multiple input beams from multiple separate emitters.

The present invention is thus an improved apparatus and method for solving problems and addressing dictates of the prior art. The benefits discussed above and other benefits will become apparent from the following description by reference to the accompanying drawings.

### BRIEF DESCRIPTION OF THE DRAWINGS

FIG. 1 is a plan view of a controllable diffraction grating suitable for use with one embodiment of the apparatus and method of the present invention;

FIGS. 2a and 2b illustrate the vertical translation of grating elements in a controllable diffraction grating which can be utilized in accordance with the present invention;

FIG. 3 is a schematic diagram illustrating operation of apparatus in accordance with the present invention in which an input light beam is separated into a plurality of optical individual streams of light, each having a different wavelength band, which are then directed to separate optical output fibers;

FIG. 4 is a schematic diagram of the embodiment shown in FIG. 3 with the output optical signals carried on individual light streams, each having a different wavelength band, switched to a different combination of optical output fibers;

FIG. 5 is a schematic diagram illustrating an operation in which one of the optical output signals is directed to multiple optical output fibers, and in which multiple optical signals are combined and directed to one optical output fiber;

FIG. 6 is a schematic diagram illustrating an operation of apparatus in accordance with the present invention in which multiple optical input signals are redirected and provided to multiple optical output fibers;

FIG. 7 is a schematic diagram illustrating an operation of apparatus in accordance with the present invention in which multiple optical signals are provided to one optical output fiber;

FIG. 8 is a functional schematic illustration of a diffracting member in the form of a controllable diffraction grating employing reflective grating elements to effect diffraction of an incoming light stream; and

FIG. 9 is a functional schematic illustration of a diffracting member in the form of a controllable diffraction grating employing transmissive grating elements to effect diffraction of an incoming light stream.

### DETAILED DESCRIPTION OF THE INVENTION

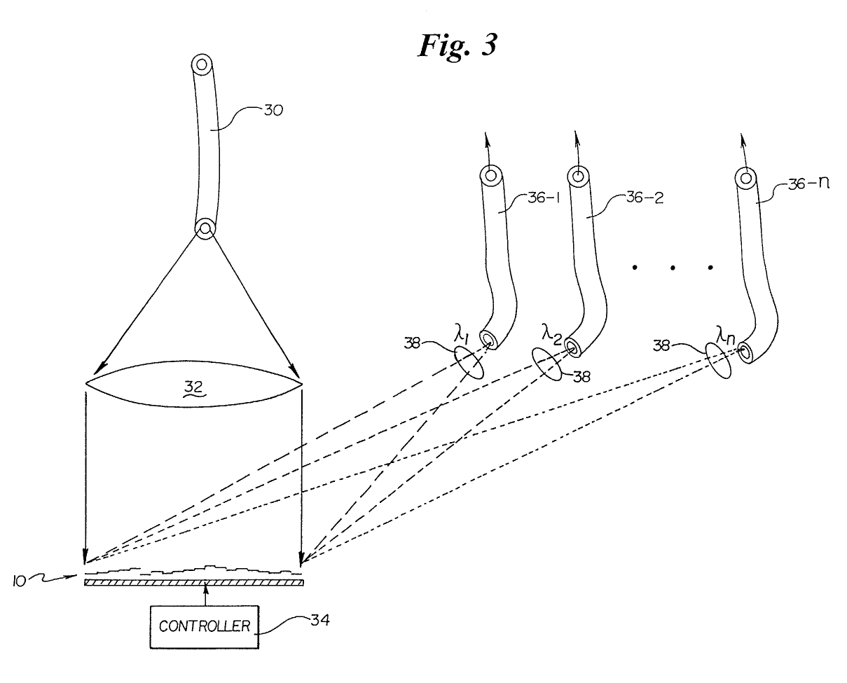

The present invention is an apparatus and method for processing light. The apparatus functions to distribute and direct one or more optical signals, having different wavelength bands, emanating from one or more optical inputs, such as input fiber 30 as seen in FIG. 3, to one or more optical outputs positioned at defined locations. The optical signals can be distributed and directed to the desired output locations independently of one another. The pattern of distribution of these signals can be volitionally selected and can be switched and rearranged from one distribution pattern to another. In effecting such switching, each optical signal can be redirected independently of the other signals.

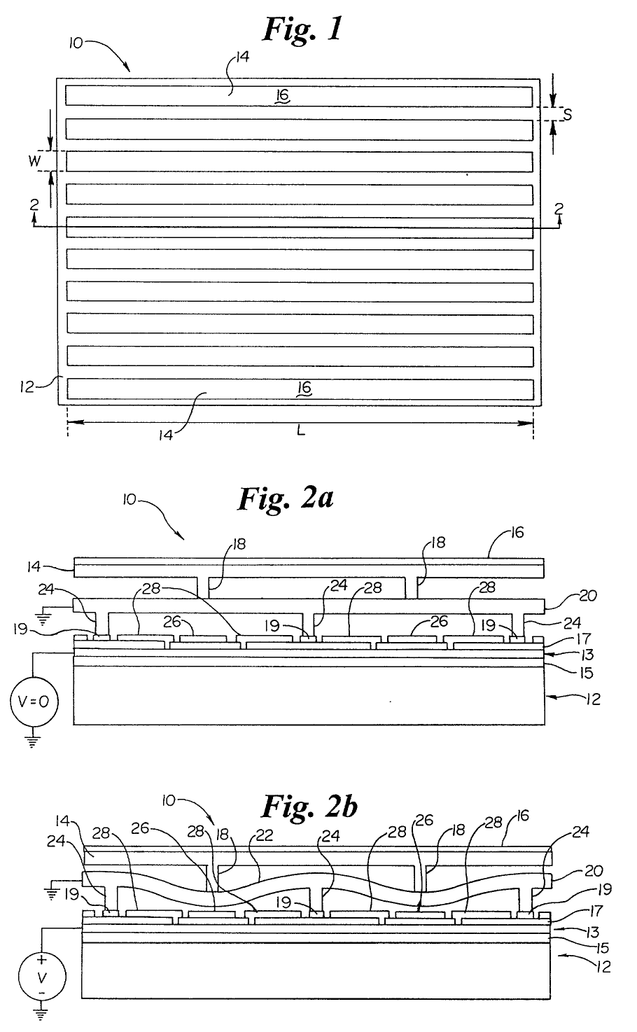

As will be discussed hereinafter with reference to a specific embodiment of the invention, positions of the grating elements 14 of FIGS. 1, 2a and 2b within a controllable diffracting grating 10 can be varied in a direction generally perpendicular to a plane defined by a coplanar configuration of elements 14. Such positional adjustment functions to effect an optical phase shift (or, less ideally, regulation of amplitude) of the light emanating from the optical input or inputs. Control of these processes is achieved by use of a controller 34 as in FIG. 3. As will be discussed hereinafter, grating elements 14 can be either reflective or transmissive. In either case, phase shift or amplitude regulation is controlled by the controller 34. Again, such adjustments can accomplish individual control of the various wavelength bands of the light stream.

The set of phase shifts for each of the grating elements 14 which are required to generate any desired distribution pattern can be calculated. A variety of diffraction models can be employed for this purpose. The most simple model, and one which applies when the width of the individual grating elements is larger than the wavelength being focused upon, is Fraunhoffer diffraction. In this model, the diffraction from the array of grating elements 14 is determined by the Fourier transform of the phase profile imposed upon an incident optical wavelength band by the grating array. Thus, the problem of designing the phase profile is equivalent to finding a profile whose Fourier transform exhibits the appropriate spatial and spectral properties. This type of calculation is known as a “phase retrieval” problem.

For a very simple switching application consisting of one input direction, one wavelength, and one output direction, the phase profile produced by the array need only contain a single spatial frequency. More complicated switching applications consisting of multiple input wavelengths and multiple output directions require the phase profile to contain a large number of spatial frequencies. In such a case, there are a number of phase retrieval algorithms such as Iterative Fast-Fourier Transform (IFFT), simulated annealing, and genetic algorithms, that can be employed to determine the appropriate deflection profile.

In the Fraunhoffer diffraction regime, Fourier transforms and inverse Fourier transforms are used to move back and forth between x-space (defined as the positional space measure along the grating array) and u-space, where u is defined by the formula:

$$u = \frac{sin Θ}{λ}$$

where θ is the outgoing diffraction angle, λ is the wavelength under consideration and normal incidence has been assumed for the incoming radiation. For optical switching, one must direct a series of input wavelengths (λᵢ) into a sequence of predefined output ports that are located at different diffraction angles (θⱼ). Thus, one must design the x-space phase profile φ(x) to diffract the desired fraction of the incident optical energy into each of a set of u-space points given by the formula:

$${u}_{ij} = \frac{sin {Θ}_{j}}{{λ}_{i}}$$

The desired intensity distribution into the set of u-space points defines a desired u-space spectrum. The IFFT algorithm begins by taking the square-root of the u-space spectrum to obtain the u-space amplitude profile. The u-space amplitude profile is combined with an arbitrary phase profile in order to obtain a complex u-space profile. This profile is Fourier transformed to x-space, yielding a complex x-space profile. The amplitude of the x-space profile is replaced by a profile that represents the known input intensity profile, while the phase of the x-space profile is retained. The x-space profile is then transformed back to u-space, where the amplitude is replaced by the desired u-space amplitude and, once again, the phase is retained. This procedure is repeated until the u-space amplitude profile obtained by transforming the x-space profile converges on the desired u-space amplitude. At this point, the x-space phase profile is the phase profile that should be produced by the grating array.

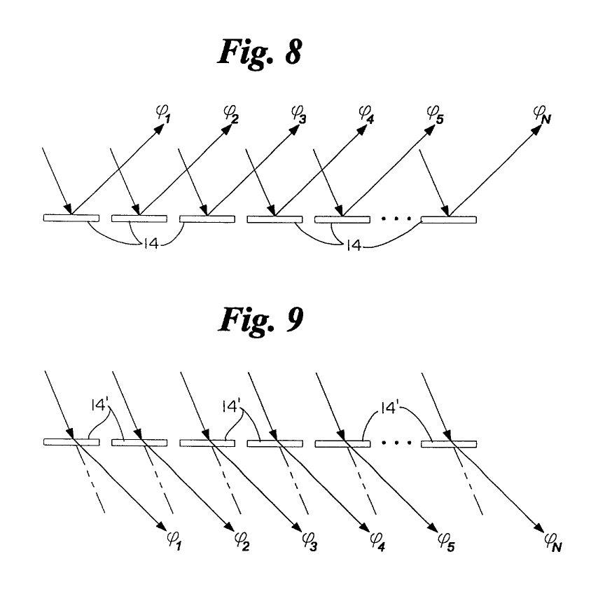

As previously mentioned, the grating elements 14 can be either reflective or transmissive. FIGS. 8 and 9, respectively, schematically illustrate these two types of diffraction. FIG. 8 illustrates a series of grating elements 14 which diffract the incident light with each element creating an individually controllable relative phase shift (φᵢ-φ_{N}. Although not essential to the invention, the grating elements 14 shown in FIG. 8 are illustrated in a coplanar configuration. Again, however, it will be understood that their relative locations can be adjusted (typically, up and down as viewed in FIG. 8) in order to adjust the relative phase shifts and thus effect diffraction of the wavelength bands to desired spatial locations at which receptors are positioned.

FIG. 9 illustrates a situation where the grating elements 14′ are transmissive. This can be the case where the elements 14′ are, for example, liquid crystals. The incident light is diffracted by the grating elements 14′ with each element providing an individually controlled relative phase shifts φᵢ-φ_{N}. As in the case of FIG. 8, grating elements 14′ in FIG. 9 are shown in a coplanar configuration. Again, the relative phase shift of the light diffracted by of these elements 14′ can be adjusted (typically by application of a voltage to each of the liquid crystal elements to adjust the optical path length) to vary the spatial positions to which the wavelength bands are diffracted.

Referring now to FIGS. 1, 2a, and 2b, a controllable diffraction grating 10 is described. Those figures illustrate construction of a controllable diffraction grating for use in accordance with the present invention. FIG. 1 is a top plan view of a controllable diffracting grating device that may be utilized with the present invention. It will be understood, however, that, while a specific controllable diffraction grating structure is illustrated, other structures are specifically contemplated for effecting diffraction of light in accordance with the present invention. For example, liquid crystals, etc., as discussed hereinbefore, could also be used as the diffractive element.

The device shown generally includes an array of elements 14 for diffracting the incoming light. Also shown are a support to which the grating elements are mounted, and means for selectively adjusting the position of the grating elements relative to the incoming light so that the direction in which each wavelength band of light diffracts can be varied and a wavelength band is individually and selectively directed to a desired receptor. In this device, a base substrate 12 supports the diffraction grating. The individual diffraction elements comprise grating elements 14, each having a diffraction surface 16, a resilient layer 20, and means for adjusting the position of the grating elements 14 provided by electrode 28 connected through conducting layer 13 to an electrical control voltage V. The grating elements 14 and resilient layer 20 are spaced from each other by support members 18, and the resilient layer 20 is spaced from the base substrate 12 by support members 24. The device also comprises additional layers 15 and 17 that provide electrical insulation, grounded electrodes 26, and ground connections 19 to the resilient layer 20. The specific details of a similar device to that shown in FIGS. 1, 2a and 2b are discussed in U.S. Pat. No. 5,757,536 to Ricco et al. and in U.S. patent application Ser. No. 09/537,936 to Elmer Hung et al. These are hereby incorporated by reference.

As shown in FIGS. 3-7, an apparatus configured according to the present invention can provide a variety of functions. For example, the apparatus can take a single input beam, separate it into a plurality of output light streams, each having a different wavelength band and forming a signal, and direct the output light stream to different output receptors. An input light beam could emanate from the end of an optical fiber, from an optical waveguide, or other source. Typically, an optical output fiber is placed to define each output receptor. An output receptor may also be defined by an optical detector or by an optical waveguide. The direction of each output signal can be selectively and independently adjusted to enable the output signal to enter any one or more of the output fibers.

Additionally, light from the signal may be collimated with an optical collimating device 32 prior to being provided to the controllable diffracting grating 10, and the light diffracted by the grating 10 can be focused with an optical focusing device 38 while being directed to output fibers 36. Collimating and focusing devices 32 and 38, respectively, may include one or more optical elements such as lenses, mirrors, apertures and the like.

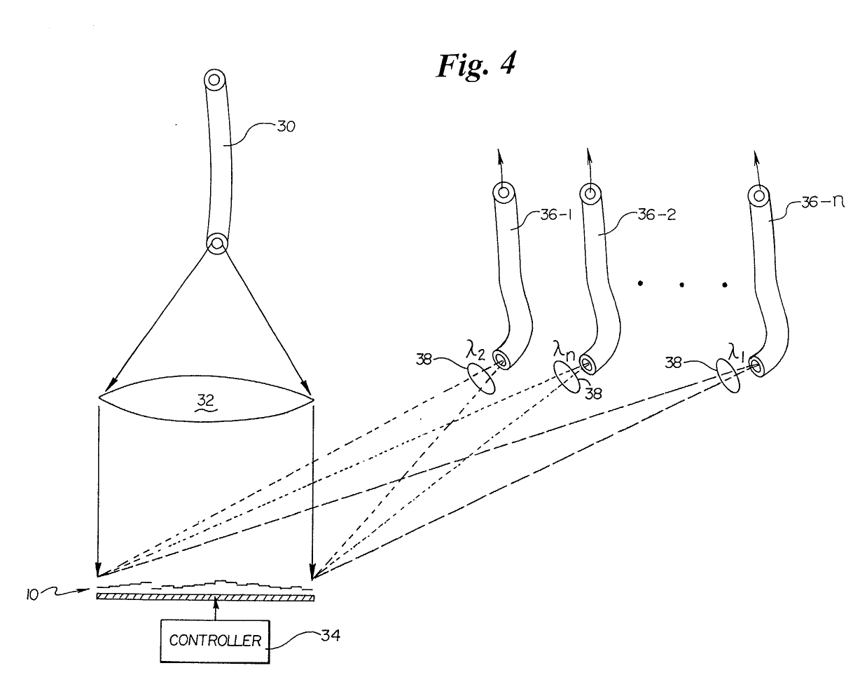

FIGS. 3-5 show some examples of the various device operations capable with the present invention. For example, as shown in FIG. 3, output signal λ₁ is directed to the leftmost output fiber 36-1, λ₂ is directed to the center output fiber 36-2, and λₙ is directed to the rightmost output fiber 36-n. In FIG. 4, the directions of the output signals have been changed, by operating grating members 14, and they are shown as entering different output fibers. As shown in FIG. 4, output signal λ₁ is directed to the rightmost output fiber 36-n, λ₂ is directed to the leftmost output fiber 36-1, and λₙ is directed to the center output fiber 36-2. These changes in the direction are made by the precise arrangement of the positions of the different grating elements 14 to achieve the phase shifts calculated by the method previously described, and as implemented by controller 34. In order to effectuate a change in the directions of the output signals, the positions of the grating elements are reconfigured into a new arrangement, calculated as described previously.

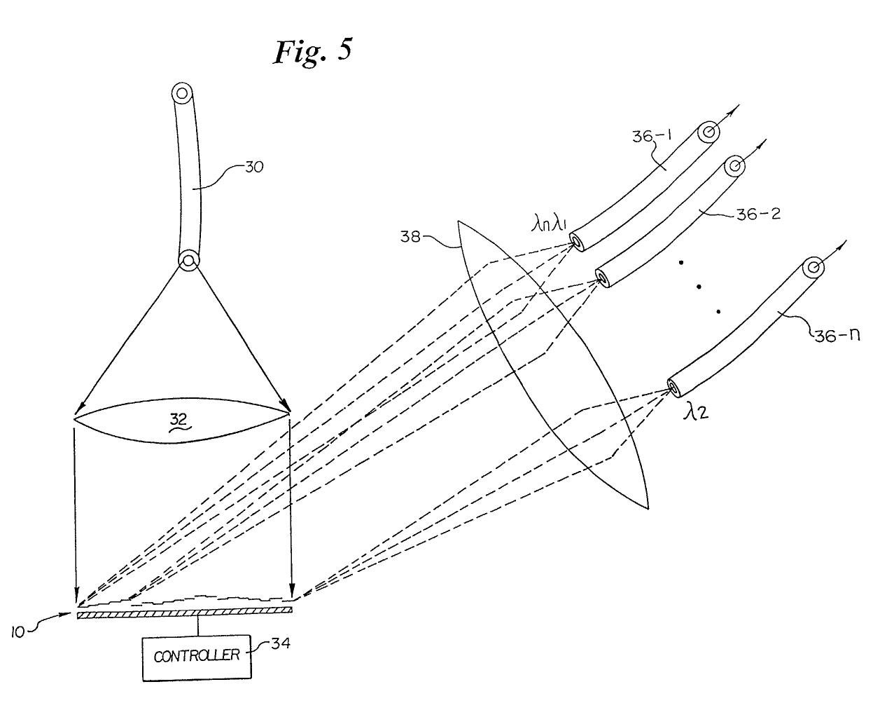

FIG. 5 shows two other types of output operations capable with a device in accordance with the present invention. As shown, both of the output signals λ₁ and λₙ are directed to the leftmost output fiber 36-1, while λ₂ is directed to both the center output fiber 36-2 and the rightmost output fiber 36-n. The directing of signals λ₁ and λₙ show that a user, connected to a particular output fiber 36-1, can receive a large amount of information at once. The directing of signal λ₂ shows that several users can receive the same information at the same time.

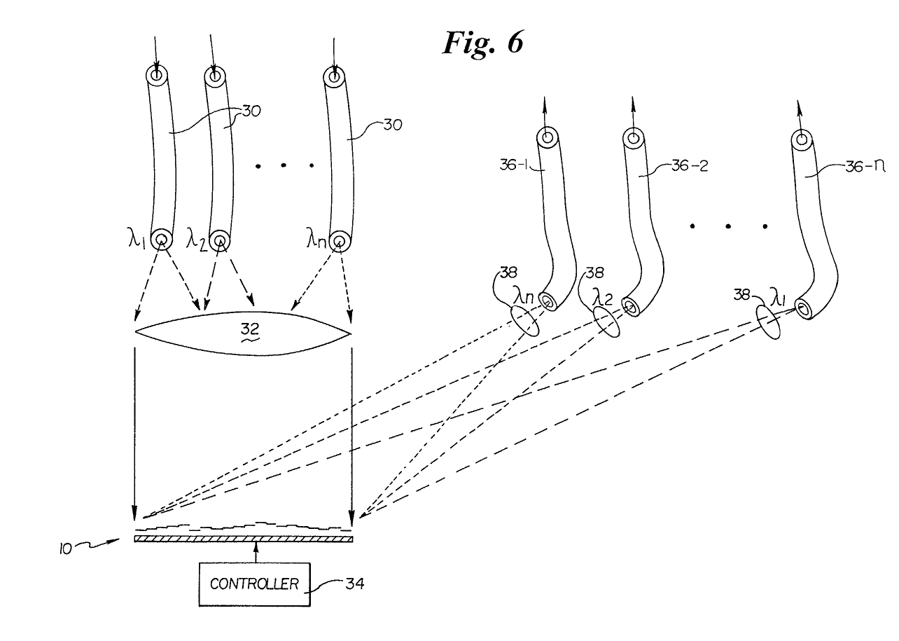

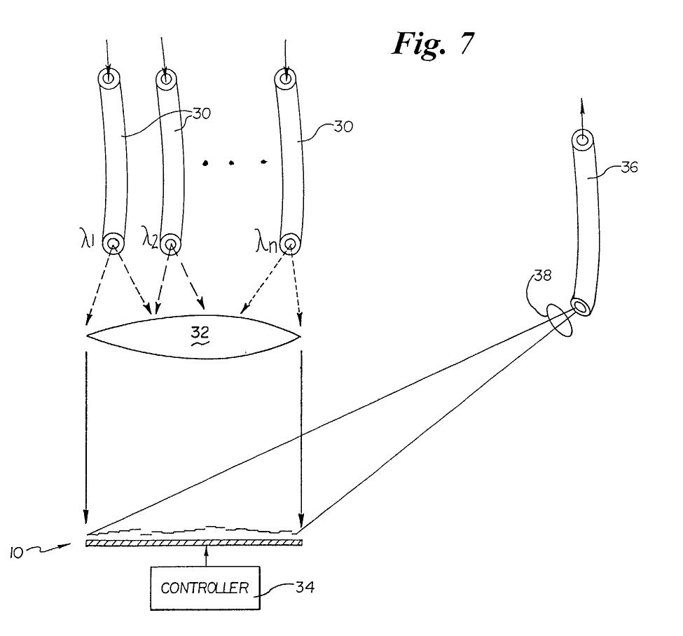

The device of the present invention may also be utilized to receive input beams from several fibers or other sources at the same time. In FIG. 6 the device takes several input signals from multiple input sources and selectively directs them to several output fibers 36-1-36n. In FIG. 7, the device takes several input signals from multiple input fibers 30 and directs them into a single output fiber 36. In an alternative embodiment, fibers 30 can be replaced by an array of individual waveguides.

The controller 34 is a device that directs movement of the individual grating elements into the proper positioning to effectuate the direction of the output signals to the correct output fibers 36. The controller 34 may include one or more electronic control circuits for addressing and actuating the grating elements 14 of programmable wavelength selective switch 10. Controller 34 may also include a microprocessor or means for accessing the controller by an external microprocessor or computer.

The position of the grating elements is provided, as shown, by selectively adjusting the positions of the grating elements relative to the incoming light so that adjustment of the grating elements changes the relative optical phase of light diffracted from each element, and hence the direction in which each wavelength band, or wavelength bands, of light is individually and selectively directed to a desired receptor. Any means known in the art may, however, be utilized for positioning the grating elements.

Operation of the controllable diffraction grating 10 is illustrated in FIGS. 2a and 2b. During operation of controllable diffraction grating 10, each grating element 14 is translated in a direction generally perpendicular with respect to the underlying base 12. Translation is provided by applying a voltage to one or more actuating electrodes 28, thereby forming an air gap capacitor between one or more actuating electrodes 28 and resilient member 20, which can be grounded. The resultant electrostatic force of attraction tends to flex resilient member 20, and in turn move grating element 14 toward the actuating electrodes 28. Landing electrodes 26 prevent resilient member 20 from contacting one or more of the actuating electrodes 28. By calibrating the electromechanical characteristics of the grating element, the voltage required to move each grating element to a desired position may be calculated.

It will be understood that, irrespective of the diffraction operation illustrated in FIGS. 3-7 being performed, the present invention enables selective and independent direction and redirection of a single wavelength band of light or multiple wavelength bands of light to be accomplished. This can be done independent of the status of other bands of light. The present invention thus affords significantly greater versatility than that presently known in the art.

It will be understood that this disclosure, in many respects, is only illustrative. Changes may be made in details, particularly in matters of shape, size, material, and arrangement of parts without exceeding the scope of the invention. Accordingly, the scope of the invention is as defined in the language of the appended claims.

What is claimed is:

1. Apparatus for processing light, comprising:
(a) an emitter for transmitting light including multiple wavelength bands generally along an axis, each band including a distinct related range of collateral wavelengths;
(b) a plurality of spatially positioned receptors;
(c) a diffracting member for diffracting said wavelength bands to various of said receptors; and
(d) a controller for selectively adjusting said diffracting member to independently vary the receptor to which each wavelength band is diffracted.

2. Apparatus in accordance with claim 1 wherein said diffracting member is a controllable diffraction grating.

3. Apparatus in accordance with claim 2 wherein said controllable diffraction grating comprises a plurality of diffractive elements, each element being individually controllable by said controller.

4. Apparatus in accordance with claim 3 wherein said elements effect diffraction by regulating the relative phase of light of said wavelength bands emanating from each element.

5. Apparatus in accordance with claim 2 wherein said controller is programmable.

6. Apparatus in accordance with claim 5 wherein said diffractive elements are controlled by said controller to vary the relative positions thereof to effect diffraction of said wavelength bands.

7. Apparatus in accordance with claim 5 wherein said diffractive elements are reflective.

8. Apparatus in accordance with claim 5 wherein said diffractive elements are transmissive.

9. Apparatus in accordance with claim 2 wherein said elements effect diffraction by regulating amplitude of said wavelength bands.

10. An optical processor, comprising:
(a) an optical input transmitting a plurality of copropagating optical signals, each signal having a distinct wavelength band;
(b) a plurality of optical outputs;
(c) a variably controllable diffraction grating member including a plurality of diffractive elements, wherein one of the relative phase shift and amplitude of said copropagating optical signals processed by each element is individually controlled; and
(d) a controller operatively connected to the variable diffraction grating member to control the wavelength bands so as to direct the plurality of copropagating optical signals to selected one or more of said optical outputs.

11. An optical processor in accordance with claim 10 wherein the copropagating optical signals define communications information.

12. An optical processor in accordance with claim 10 further comprising optics intermediate said optical input and said variable diffraction grating member to direct a copropagating optical signal onto said variable diffraction grating member.

13. An optical processor in accordance with claim 12 further comprising optics intermediate said variable diffraction grating member and an optical output to direct a copropagating optical signal onto a corresponding, selected optical output.

14. An optical processor in accordance with claim 10 wherein said optical input comprises an emitting end surface of an optical fiber.

15. An optical processor in accordance with claim 10 wherein said optical outputs comprise end surfaces of respective optical fibers.

16. An optical processor in accordance with claim 10 wherein said optical input comprises a light-emitting region of an optical wave guide.

17. An optical processor in accordance with claim 10 wherein said optical outputs comprise input surfaces of respective optical wave guides.

18. An optical processor in accordance with claim 10 wherein said elements of said variable diffraction grating member are reflective.

19. An optical processor in accordance with claim 10 wherein said elements of said variable diffraction grating member are transmissive.

20. An optical processor in accordance with claim 10 wherein said diffractive elements are controlled by said grating member to vary the relative positions thereof to effect diffraction of the wavelength band of each copropagating optical signal.

21. An optical processor in accordance with claim 10 wherein said processor comprises a plurality of optical inputs, each transmitting a copropagating optical signal having a distinct wavelength band.

22. An optical processor in accordance with claim 10 wherein said controller is electrically operated.

23. A method of processing light emanating from an input and directing each of multiple distinct wavelength bands of the light to a desired receptor, comprising the steps of:
(a) directing the light along an axis;
(b) diffracting the wavelength bands of the light in different directions; and
(c) selectively varying the direction of each wavelength band to a receptor independent of other wavelength bands.

24. A method in accordance with claim 23 further comprising the step of allowing redirection of each wavelength band to a different one of multiple receptors.

25. A method for directing a particular wavelength band of a plurality of wavelength bands of incoming light, comprising the steps of:
providing a diffraction grating including a plurality of diffraction grating elements;
calculating a position and orientation of each diffraction grating element necessary to direct a wavelength band of the incoming light to a predetermined output location; and
positioning the diffraction grating elements in calculated positions and orientations to diffract the wavelength bands of light to predetermined output locations.

26. An optical processor, comprising:
(a) a plurality of optical inputs, each transmitting one or more copropagating optical signals, each signal having a distinct wavelength band;
(b) an optical output;
(c) a variably controllable diffraction grating member including a plurality of elements, wherein one of the relative phase shift and amplitude of said copropagating optical signals processed by each element is individually controlled; and
(d) a controller operatively connected to the variable diffraction grating member to control wavelength bands so as to direct the plurality of copropagating optical signals to said optical output.

27. An optical processor in accordance with claim 26 wherein said controller is operatively connected to the variable diffraction grating member to control the wavelength bands so as to direct the plurality of copropagating optical signals to a plurality of optical outputs.

28. A wavelength selective optical switch for directing one wavelength band of multiple bands of incoming light transmitted by an emitter, comprising:
(a) a controllable diffraction grating comprising a plurality of grating elements for diffracting the incoming light; and
(b) a controller for selectively adjusting a position of each grating element, wherein a direction in which each wavelength band of light is individually and selectively diffracted to a desired location is controlled.

29. A switch according to claim 28, wherein said controller is configured to adjust one or more of said grating elements, and wherein adjustment of said grating elements changes the direction in which each wavelength band of light is individually and selectively diffracted to predetermined locations.

30. A switch according to claim 28, wherein said controller electrostatically adjusts the position of each of said grating elements.

31. A method for directing a plurality of wavelength bands of incoming light, comprising the steps of:
providing a diffraction grating including a plurality of diffraction grating elements;
determining locations of the plurality of diffraction grating elements necessary to direct wavelength bands of the incoming light to desired output locations; and
positioning the plurality of diffraction grating elements at the determined locations to selectively diffract a wavelength band of light to a predetermined output location independently of other of the wavelength bands.
